(19) United States
(12) Patent Application Publication
(10) Pub. No.: US 2021/0092479 A1
(43) Pub. Date: Mar. 25, 2021

(54) VIDEO PROCESSING APPARATUS

(71) Applicants: SHARP KABUSHIKI KAISHA, Sakai City, Osaka (JP); FG Innovation Company Limited, Tuen Mun, New Territories (HK)

(72) Inventors: HIDEO NAMBA, Sakai City, Osaka (JP); HIROMICHI TOMEBA, Sakai City, Osaka (JP); TOMOHIRO IKAI, Sakai City, Osaka (JP); TAKASHI ONODERA, Sakai City, Osaka (JP); YASUHIRO HAMAGUCHI, Sakai City, Osaka (JP); NORIO ITOH, Sakai City, Osaka (JP)

(21) Appl. No.: 16/954,866

(22) PCT Filed: Oct. 30, 2018
(86) PCT No.: PCT/JP2018/040237

§ 371 Date: Jun. 17, 2020

(30) Foreign Application Priority Data
Dec. 28, 2017 (JP) 2017-253556

(51) Int. Cl. H04N 21/44; G06K 9/00

(52) U.S. Cl. CPC H04N 21/44008; G06K 9/00744; G06K 9/00718

(57) ABSTRACT

By transmitting region reconstruction information from a network side device to a terminal side device, quality is enhanced in video reconstruction by super resolution techniques or the like. A video is divided into multiple regions, and the region reconstruction information includes video reconstruction information for each of the multiple regions divided. The region reconstruction information is generated based on the classification information associated with the video.

### TECHNICAL FIELD

The present invention relates to a video processing apparatus.

This application claims priority to JP 2017-253556 filed on Dec. 28, 2017, the contents of which are incorporated herein by reference.

### BACKGROUND ART

In recent years, the resolution of display devices has been improved and display devices which are capable of Ultra High Density (UHD) display have emerged. A 8K Super Hi-Vision broadcast is being implemented that is a TV broadcast using around eight thousand pixels in the lateral direction for a display device capable of especially high resolution display among the UHD displays. The band of signals for supplying videos to a display device (8K display device) capable of the 8K Super Hi-Vision broadcast is very wide, and it is necessary to supply the signals at a speed of greater than 70 Gbps in uncompressing, and a speed of approximately 100 Mbps even in compressing.

In order to distribute video signals that utilize such broadband signals, the use of new types of broadcast satellites or optical fibers has been studied (NPL 1).

On the other hand, a super resolution technique, which is one of the techniques to recover, from a video with low resolution video signals, a video with a higher resolution than the original resolution, may be used to improve the quality in displaying low resolution video signals by using a high resolution display device. The low resolution video signals do not require a wide band and are operable in existing video transmission systems, and thus the low resolution video signals may be used in a case that high resolution display devices are implemented.

Various approaches have been proposed for super resolution techniques, and among them, proposals have been made to increase quality of video in a case that higher resolution video data is recovered from low resolution video data by using Artificial Intelligence (AI) technology such as neural networks, and by utilizing dictionaries or neural network parameters learned by using a large amount of training data (NPL 2).

### CITATION LIST

### Non Patent Literature

NPL 1: Ministry of Internal Affairs and Communications, “Present State About Propulsion of 4K and 8K,” Ministry of Internal Affairs and Communications Homepage, <www.soumu.go.jp/main_content/000276941.pdf> NPL 2: Chao, et. al., “Image Super-Resolution Using Deep Convolutional Networks,” February 2016, IEEE TPAMI

### SUMMARY OF INVENTION

### Technical Problem

However, even in a case that signals obtained by compressing video are used, the band required for one video signal is very wide, and the band required to transmit multi-channel video is even wider. There is a problem that a new band to be used for 8K resolution cannot be prepared for the purpose of performing video transmission of 8K resolution (7680×4320 pixels) in addition to video transmission by video signals of conventionally used resolutions, for example, 1980×1080 pixel resolution (hereinafter, HD resolution) or 3840×2160 pixel resolution (hereinafter, 4K resolution).

While there are methods for transmitting low resolution video signals, recovering high resolution video signals from the low resolution video signals by super resolution techniques, and using super high resolution display devices, there are numerous methods of processing used as super resolution techniques, and there are problems in that the quality of the output video varies depending on the input video. The conversion of low resolution video signal to 8K resolution video signal by super resolution processing using a neural network is effective in a case that there is good quality learning data, but it is difficult to generate a high quality super resolution neural network for every video, and the amount of computation and training data required to generate good quality learning data required for neural network generation are enormous, thus resulting in significant cost.

An aspect of the present invention has been made in view of the above problems, and discloses a device and a configuration thereof that enhance quality in video reconstruction by super resolution technology or the like by transmitting region reconstruction information from a network side device to a terminal side device.

### Solution to Problem

(1) In order to achieve the object described above, according to an aspect of the present invention, a video processing apparatus is provided including: a data input unit configured to acquire a first video; a video processing unit configured to divide the first video into multiple regions and generate multiple pieces of region reconstruction information associated with the first video for each of the multiple regions; and a data output unit configured to transmit the multiple pieces of the region reconstruction information to a terminal side device connected via the prescribed network.

(2) In order to achieve the object described above, according to an aspect of the present invention, a video processing apparatus is provided in which the video processing unit acquires information associated with a method for generating the region reconstruction information from the terminal side device.

(3) In order to achieve the object described above, according to an aspect of the present invention, a video processing apparatus is provided in which each of the region reconstruction information generated for each of the multiple regions has an different amount of information.

(4) In order to achieve the object described above, according to an aspect of the present invention, a video processing apparatus is provided in which the data input unit acquires classification information associated with the first video, and the video processing unit generates the region reconstruction information, based on the classification information.

(5) In order to achieve the object described above, according to an aspect of the present invention, a video processing apparatus is provided in which the data input unit further requests a request of the region reconstruction information for the video processing unit configured to generate the region reconstruction information.

(6) In order to achieve the object described above, according to an aspect of the present invention, a video processing apparatus is provided in which the request of the region reconstruction information includes a type of the region reconstruction information.

(7) In order to achieve the object described above, according to an aspect of the present invention, a video processing apparatus is provided in which the request of the region reconstruction information includes a parameter related to the classification information.

### Advantageous Effects of Invention

According to an aspect of the present invention, the use of the region reconstruction information generated on the network side device can contribute to the improvement of the display quality of the terminal side device.

### BRIEF DESCRIPTION OF DRAWINGS

FIG. 1 is a diagram illustrating an example of a configuration of a device according to an embodiment of the present invention.

FIG. 2 is a diagram illustrating an example of region division according to an embodiment of the present invention.

FIG. 3 is a diagram illustrating an example of region division and ranking according to an embodiment of the present invention.

FIG. 4 is a diagram illustrating an example of a configuration of a terminal side device according to an embodiment of the present invention.

FIG. 5 is a diagram illustrating an example of a configuration of a super resolution processing unit according to an embodiment of the present invention.

### DESCRIPTION OF EMBODIMENTS

Hereinafter, a wireless communication technology according to an embodiment of the present invention will be described in detail with reference to the drawings.

### First Embodiment

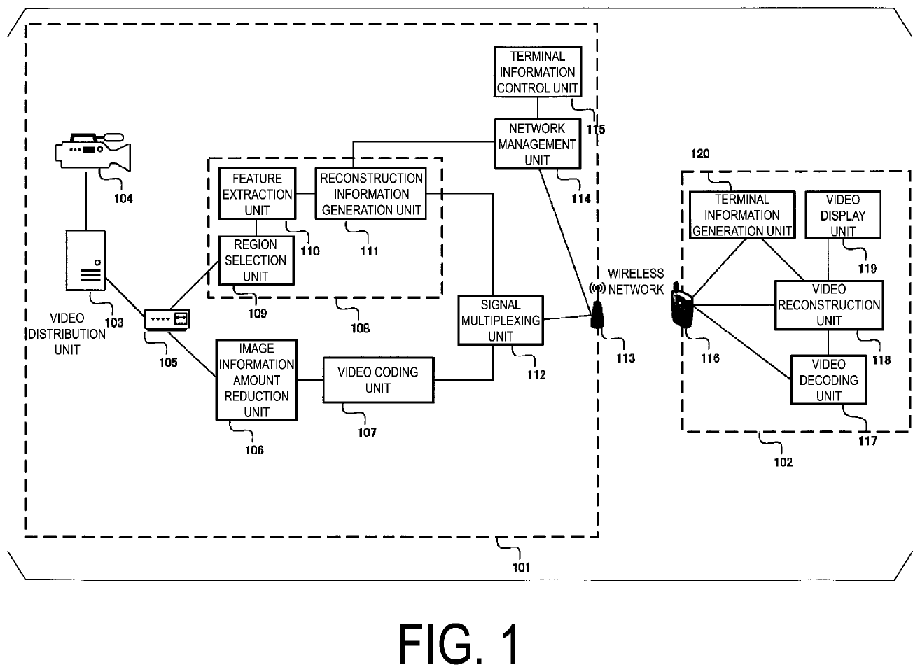

An embodiment of the present invention will be described in detail below with reference to the drawings. FIG. 1 illustrates an example of a configuration of a device according to the present embodiment. The present embodiment includes a network side device 101 and a terminal side device 102. Each of the network side device 101 and the terminal side device 102 include multiple functional blocks. The network side device 101 and the terminal side device 102 need not be constituted by one device, but may be constituted by multiple devices including one or multiple functional blocks. These devices may be included in a device such as a base station apparatus, a terminal apparatus, and a video processing apparatus.

In the present embodiment, the network side device 101 and the terminal side device 102 are connected via a network, and a wireless network is used as the network. The method of the wireless network used is not particularly limited, and may use a public network such as a cellular wireless communication network represented by a mobile phone or the like and a wired communication network by optical fibers using Fiber To The x (FTTx), or a self-management network such as a wireless communication network represented by a wireless LAN or a wired communication network using twisted pair lines. It is necessary for the network to have the capability required to transmit reconstruction information for each region with the coding video data having a reduced amount of image information to be described later (a sufficiently wide band and sufficiently less harmful disturbance such as transmission error or harmful jitter). In the present embodiment, a cellular wireless communication network is used.

Next, functional blocks of the network side device 101 will be described. 103 is a video distribution unit configured to supply a super high resolution video, for example, video data obtained by coding a video signal including 7682 pixels×4320 pixels (hereinafter, 8K video signal), and 104 is a video signal supply unit configured to supply one or more 8K video signals to the video distribution unit 103. The coding scheme used by the video distribution unit 103 is not particularly limited, and both of coding for compressing the video such as H.264 scheme, H.265, or VP9 scheme, and coding for video transmission such as MPEG2-TS scheme or MPEG MMT scheme may be performed. Alternatively, the video distribution unit 103 may not perform the coding for compressing the video. The video signal supply unit 104 is not particularly limited as long as it is a device capable of supplying video signals, and may use a video camera that converts an actual video to video signals by using imaging elements, a data storage device in which video signals are recorded in advance, and the like. 105 is a network device configured to constitute a network in the network side device 101 to enable data exchange between the video distribution unit 103, the region reconstruction information generation unit 108, and the image information reduction unit 106. The region reconstruction information generation unit 108 includes a region selection unit 109, a feature extraction unit 110, and a reconstruction information generation unit 111. 106 is an image information amount reduction unit configured to convert the resolution of 8K video supplied from the video distribution unit 103 to low resolution and reduce the amount of information included in the image, and 107 is a video coding unit configured to code low resolution video data output by the image information amount reduction unit 106. The resolution of the low resolution video data generated by the image information amount reduction unit 106 is not particularly specified, but is a video of 3840×2160 pixels (hereinafter, 4K video) in the present embodiment. The coding scheme performed by the video coding unit 107 is not particularly limited, and both of coding for compressing the video, such as H.264 scheme, H.265, or VP9 scheme, and coding for video transmission such as MPEG2-TS scheme or MPEG MMT scheme may be performed. 112 is a signal multiplexing unit configured to multiplex the region reconstruction information output by the region reconstruction information generation unit 108 and the low resolution video coded data output by the video coding unit 107, and code the multiplexed data such that the transmission is performed from the base station apparatus 113 by using one connection. In the present embodiment, in a case that the region reconstruction information and the low resolution video coded data are multiplexed and coded and that the low resolution video coded data is coded for video transmission, the low resolution video coded data and the region reconstruction information may be transmitted by using different connections among multiple connections. 113 is a base station apparatus configured to transmit the region reconstruction information and the low resolution video coded data to the terminal side device 102, 114 is a network management unit configured to manage the wireless network, and 115 is a terminal information control unit configured to manages a terminal apparatus connected to the wireless network. Although the network side device 101 is described as a single device for convenience in the present embodiment, the network side device 101 may be constituted by multiple devices, and each of the functional blocks such as the video distribution unit 103, the video signal supply unit 104, the region reconstruction information generation unit 108, the image information reduction unit 106, the video coding unit 107, and the signal multiplexing unit 112 may be present as a separate video processing apparatus, or multiple functional blocks may be collectively present as a video processing apparatus.

Next, functional blocks of the terminal side device 102 will be described. 116 is a terminal wireless unit configured to communicate with the base station apparatus 113 to exchange data between the network side device 101 and the terminal side device 102; 117 is a video decoding unit configured to extract low resolution video coded data from the data exchanged by the terminal wireless unit with the base station apparatus 113, decode the extracted low resolution video coded data, and output a low resolution video, or a 4K video in the present embodiment; 118 is a video reconstruction unit configured to extract region reconstruction information from the data exchanged by the terminal wireless unit 116, perform super resolution processing on the video output by the video decoding unit 117 by using the region reconstruction information, and reconstruct a high resolution video, or an 8K video in the present embodiment; and 119 is a video display unit configured to display the video reconstructed by the video reconstruction unit 118. The video display unit 119 is capable of displaying an 8K video. 120 is a terminal information generation unit configured to exchange data with the network management unit 114 in the network side device 101 via the terminal wireless unit 116, transmit information of the terminal side device 102 to the network management unit 114, and receive information available for video reconstruction from the network management unit 114.

Next, the region reconstruction information generation unit 108 of the network side device 101 performs processing on the first video data input from the network device 105. In other words, the region reconstruction information generation unit 108 can include a data input unit configured to acquire the first video data. The region reconstruction information generation unit 108 divides the first video data into multiple regions, performs processing on each of the regions, and generates region reconstruction information associated with the first video data for each of the regions. In other words, the region reconstruction information generation unit 108 can include a video processing unit configured to process the first video data. The region reconstruction information generation unit 108 can include a data output unit configured to output the region reconstruction information. The data output unit can output the region reconstruction information for each of the divided regions. A specific device configuration and signal processing of the region reconstruction information generation unit 108 will be described below.

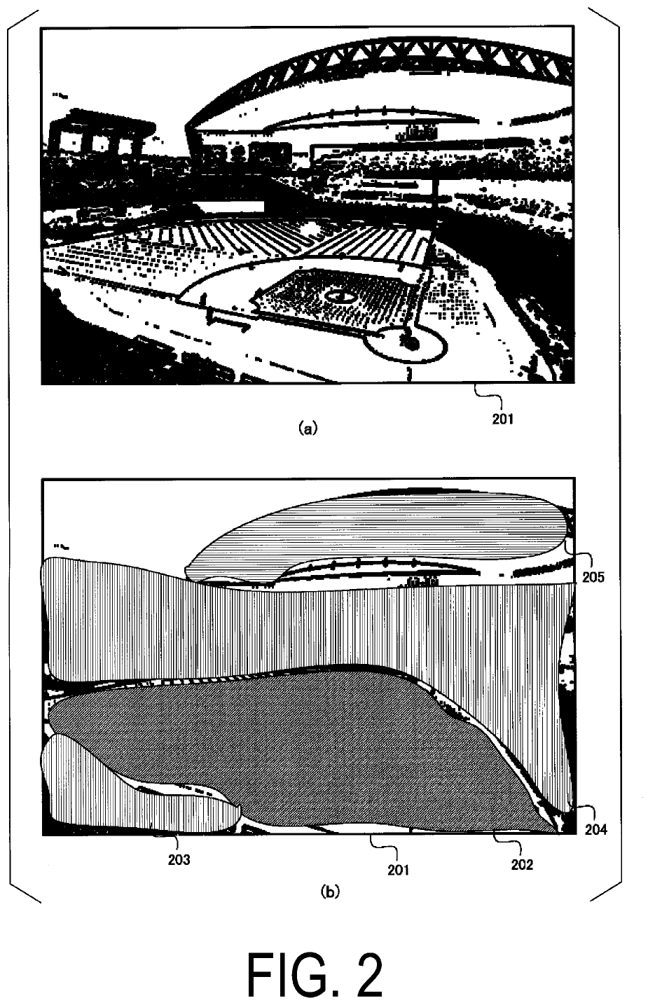

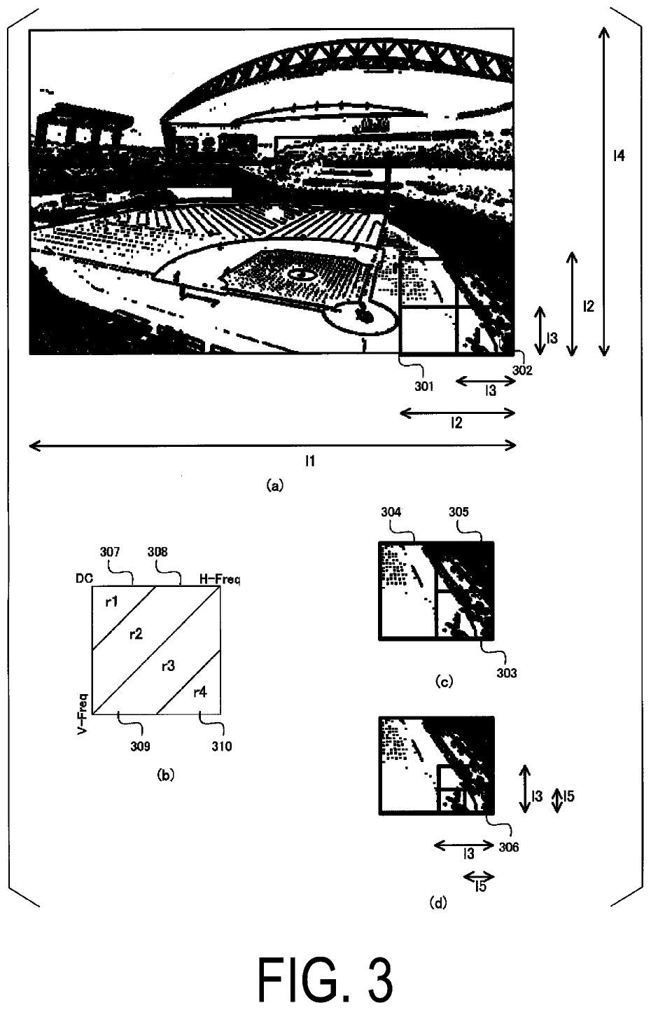

The operation of the region reconstruction information generation unit 108 will be described with reference to FIG. 2 and FIG. 3. FIG. 2(a) illustrates an example of video data 201 input to the region reconstruction information generation unit 108, and FIG. 2(b) illustrates an example in which multiple regions 202 to 205 are extracted, each of the multiple regions including portions that have similar characteristics in the example of the video data 201. The region 202 is a region corresponding to a ground where there is little change in distribution of luminance and color, the region 203 and the region 204 are regions corresponding to audience seats in which a number of spectators and chairs are arranged where there is a large change in distribution of luminance and color, and the region 205 is a region corresponding to a roof where there is a large change in distribution of changes in luminance but there is less change in distribution of color. The process of extracting these regions will be described with reference to FIG. 3.

FIG. 3(a) illustrates four 13×13 regions 302 included in an 12×12 region 301 in the video data with resolution 11×14. The present embodiment assumes a relationship of 11>14>12>13. Whether each of the multiple 13×13 regions 302 has similar distribution of luminance and distribution of color is examined, and in a case that there are regions with similar distribution, the regions are managed as regions with identical characteristics. In order to examine the distribution of luminance and the distribution of color, the video data in the 13×13 region 302 is separated into luminance information and chrominance information, and two-dimensional discrete cosine transform (2D-DCT) is performed on each of the luminance information and the chrominance information. In a case that 2D-DCT is performed on the video data, the resultant video data arranged in two dimensions appears as illustrated in FIG. 3(b). The example of FIG. 3(b) illustrates frequencies in the right and horizontal direction from the vertex of the upper left representing the direct current (DC) component, and the further away to the right side from the point representing the DC component, the higher the frequency component is in the horizontal direction. Similarly, the further away to the lower side direction from the point representing the DC component, the higher the frequency component is in the vertical direction. The absolute values of the values of each point resulting from the 2D-DCT are evaluated at a threshold value, and the points at which the value exceeds the threshold value are replaced with 1, and the points at which the value is less than or equal to the threshold value are replaced with 0. Then, rank 4 is set in a case that 1 is included in region r4 (310), otherwise rank 3 is set in a case that 1 is included in region r3 (309), otherwise rank 2 is set in a case that 1 is included in region r2 (308), and otherwise rank 1 is set. Ranking is performed by performing 2D-DCT for each of the luminance signal and the chrominance signal. The threshold value used during the ranking may be a prescribed value, or may be a value that is changed depending on the video data input to the region reconstruction information generation unit 108. A region with a higher rank is a region where the luminance information or the chrominance information includes a higher frequency component, in other words the change in distribution is larger. Note that hue information may be used instead of the chrominance information.

An example of a result from ranking performed for four 13×13 regions 302 and grouping of regions of the same rank is illustrated in FIG. 3(c). The region where the ranking results of the luminance information is rank 1 is 304, the region with rank 2 is 303, and the region with rank 3 is 305. Since most video signals have the spreading in the frequency direction of the chrominance information less than the spreading in the frequency direction of the luminance information, in a case that ranking is performed on a certain region, it is often the case that the rank of the luminance information is high but the rank of the chrominance information is low, so the rank is most likely to be rank 1, for example. In contrast, in a case of a video in which the chrominance varies clearly in the region, for example, a video in which a portion representing a ground and a portion representing audience seats are included as illustrated in the region 303 of FIG. 3(c), the rank of the hue signal may be high. In such a case, the region may be further divided and re-evaluated, and the rank of the regions resulting from the division may be re-evaluated. FIG. 3(d) illustrates an example of re-dividing the 13×13 region 303 into four 15×15 regions. Because the target region is smaller, the value resulting from the 2D-DCT gets smaller. The threshold value used for ranking may be changed depending on the size of the region to which 2D-DCT is applied. In a case that the region to be evaluated becomes smaller, the maximum rank value may be limited.

In the above, a procedure of the ranking is illustrated by dividing the 12×12 region 301 into small regions, for example, 13×13 regions, or 15×15 regions. In a similar manner, the ranking is performed by dividing the 11×12 region into small regions. As a result of the ranking, it is possible to extract regions that have similar spreading of the frequency of the luminance information in a range where the spreading of the frequency of the chrominance information is small. For each of the regions that have similar spreading of the frequency of the luminance signal, the average chrominance in the region is examined and adjacent regions having a high correlation of chrominance are combined, and thereby the 11×12 region can be divided into regions each of which has similar spreading of the frequency of the luminance information and similar chrominance.

Reconstruction information is generated for each region that has similar spreading of the frequency of the luminance information and similar chrominance. This reconstruction information (region reconstruction information) may include any information that is useful for the terminal side device 102 in reconstruction of the video. The processing used in reconstruction of the video may include super resolution processing. This region reconstruction information may be referred to as a super resolution parameter. In the present embodiment, the rank information for indicating the spreading of the frequency of the luminance information in the region and information for indicating the shape of the region corresponding to the rank information are included. There may be multiple formats of information for indicating the shape of the region, and coordinate data of multiple vertices may be used that indicates the shape of the region and the number of pixels in the vertical and horizontal directions of the video signal input to the region reconstruction information generation unit 108, or it may be specified by grid numbers obtained by dividing pixels in the vertical and horizontal directions of the video signal input to the region reconstruction information generation unit 108 by a number of grids and assigning a number to each grid. Rather than specifying the coordinate data in pixel units, the coordinate data may be specified by using a value normalized by the number of pixels in the horizontal direction or the number of pixels in the vertical direction of the video signal input to the region reconstruction information generation unit 108. Information corresponding to each region may include the type of dictionary to be used as one method of video reconstruction or the range of index to be used. A dictionary to be used as one method of video reconstruction may include network configurations as neural network information or parameters thereof. For example, the information of a neural network includes, but is not limited to, a kernel size, the number of channels, the size of input/output, a weight coefficient or offset of the network, the type and parameters of activation function, parameters of a pooling function, and the like. This dictionary information may be managed by the network management unit 114 and may be associated with information exchanged with the terminal side device 102.

The above procedure is performed by the region selection unit 109, the feature extraction unit 110, and the reconstruction information generation unit 111 in the region reconstruction information generation unit 108 in cooperation. The region selection unit 109 buffers the video data input to the region reconstruction information generation unit 108, and extracts the video data in the region in which the feature extraction unit 110 performs 2D-DCT to be used for feature extraction. The feature extraction unit separates the video data extracted by the region selection unit 109 into luminance information and chrominance information, then performs 2D-DCT, and performs ranking on the region. The correlation of the average chrominance of adjacent regions of the same rank is examined and regions with high correlation are combined. The reconstruction information generation unit 111 uses the shape information and the rank of the region output by the feature extraction unit 110 to generate the region reconstruction information. The region reconstruction information generates information corresponding to one video displayed in a unit time by the terminal side device 102 so that the terminal side device 102 can identify the information. For example, in a case that a time stamp or a frame number is included in the video data input to the region reconstruction information generation unit 108, the region reconstruction information may be generated in association with the time stamp and the frame number. By omitting information related to a region using the same reconstruction information as the immediately preceding frame, the region reconstruction information may be reduced.

The signal multiplexing unit 112 multiplexes the low resolution video coded data output by the video coding unit 107 and the region reconstruction information output by the region reconstruction information generation unit 108. The multiplexing method is not particularly specified, but may use a coding method for video transmission such as MPEG2-TS or MPEG MMT. At this time, the region reconstruction information and the low resolution video coded data are multiplexed so as to have a time synchronization with each other. At this time, in a case that a time stamp or a frame number are included in the information output by the video distribution unit 103, the time stamp or the frame number may be used to multiplex the information. In a case that the video coding unit 107 performs coding for video transmission, the signal multiplexing unit 112 may multiplex the region reconstruction information by using the multiplexing scheme used by the video coding unit 107. The multiplexed low resolution video coded data and the region reconstruction information are transmitted to the terminal side device 102 via the base station apparatus 113.

The region reconstruction information generation unit 108 can change the processing contents of the region selection unit 109 described above, based on information related to the video classification of the first video data input. As the information related to the video classification of the first video data, the information related to the genre of the first video data (e.g., sports video, landscape video, drama video, animation video, or the like), or information related to image quality (frame rate, information related to luminance and chrominance, information related to high dynamic range (HDR)/standard dynamic range (SDR), and the like) can be used.

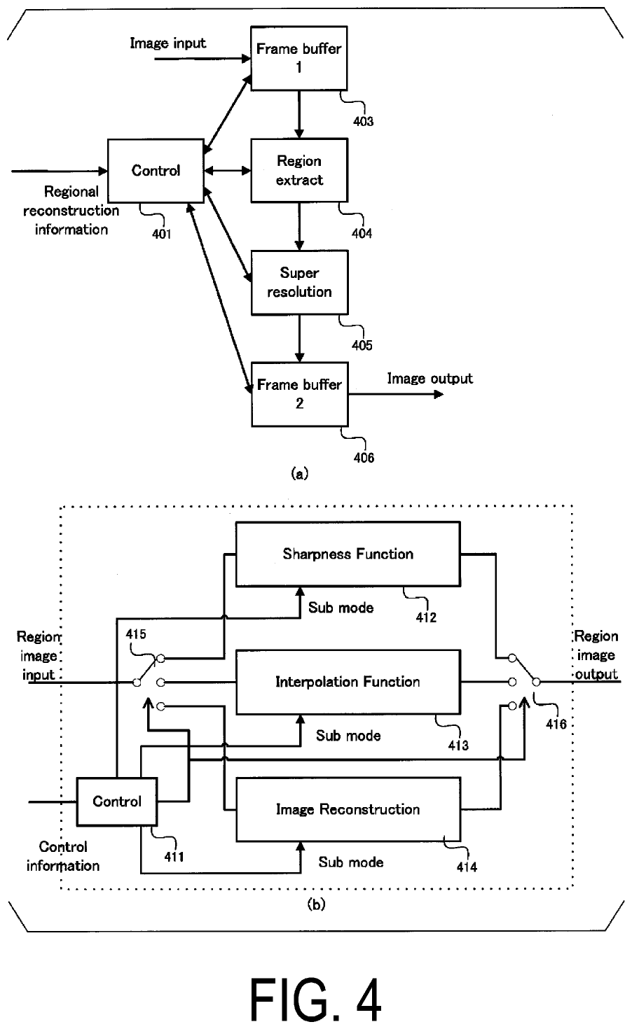

Next, the operation of the video reconstruction unit 118 of the terminal side device 102 will be described with reference to FIG. 4. FIG. 4(a) illustrates an example of functional blocks of the video reconstruction unit 118. 401 is a controller configured to input region reconstruction information and control the operation of each block in the video reconstruction unit 118; 403 is a first frame buffer unit configured to store video data input to the video reconstruction unit 118 on a per frame basis; 404 is a region extraction unit configured to extract a prescribed region from video data stored in the first frame buffer unit 403; 405 is a super resolution processing unit configured to perform super resolution processing on the video data extracted by the region extraction unit 404; and 406 is a second frame buffer unit configured to compose the video data output by the super resolution processing unit 405, generate and store video data in the frames, and output the video data sequentially.

In a case that 4K video data of one frame is accumulated in the first frame buffer unit 403, the controller 401 configures the region extraction unit 404 and the super resolution processing unit 405 to perform super resolution processing on all the regions of the one frame, and stores the data in the second frame buffer 406. The video data stored in the second frame buffer 406 is an initial value of the video data of the frame. The configuration of the super resolution processing unit 405 used to generate the initial value may use any of the super resolution processing methods and sub-modes described below, but may use a super resolution processing method having the lowest amount of calculation, for example, an interpolation function as the super resolution processing method, and may select bi-cubic as the sub-mode. Subsequently, the controller 401 configures the region extraction unit 404 to extract corresponding portions of the video data stored in the first frame buffer unit 403 from the data of the shape of the region specified by the region reconstruction information. In the present embodiment, the shape of the region is specified by pixels in 8K video in a case that the shape of the region is specified in pixel units, so the region is converted to pixels corresponding to 4K video in extracting the video data of the region from the first frame buffer unit 403. Even in a case that the shape of the region uses a normalized value, the region is converted to pixels corresponding to 4K video. The controller 401 configures the super resolution processing method and the sub-mode used by the super resolution processing unit 405, based on information corresponding to the region specified by the region reconstruction information, or the rank information related to the spreading of the frequency of the luminance information in the present embodiment. The interpolation function is used for the super resolution processing method and bi-cubic is configured for the sub-mode in a case of rank 1; the interpolation function is used for the super resolution processing method and Lanczos 3 is configured for the sub-mode in a case of rank 2; the sharpening function is used for the super resolution processing method and unsharp is configured for the sub-mode in a case of rank 3; and the sharpening function is used for the super resolution processing method and a non-linear function is configured for the sub-mode in a case of rank 4. The super resolution processing unit 405 uses the super resolution method and the sub-mode that are configured to perform super resolution processing on the video of the target region, and overwrites the video data on the second frame buffer 406 with the video data resulting from the super resolution processing. After super resolution processing is performed on all the regions included in the region reconstruction information, the super resolution processing for the frame ends, and the processing of the subsequent frame is carried out. The completed video data of the frame is output sequentially to the video display unit 119. In a case that information related to the search range of dictionary data and dictionary index for video reconstruction is acquired from the network side device 101, the super resolution processing unit 405 may be configured to use the video reconstruction function. At this time, updating of dictionary data or the like may be performed for the super resolution processing unit 405.

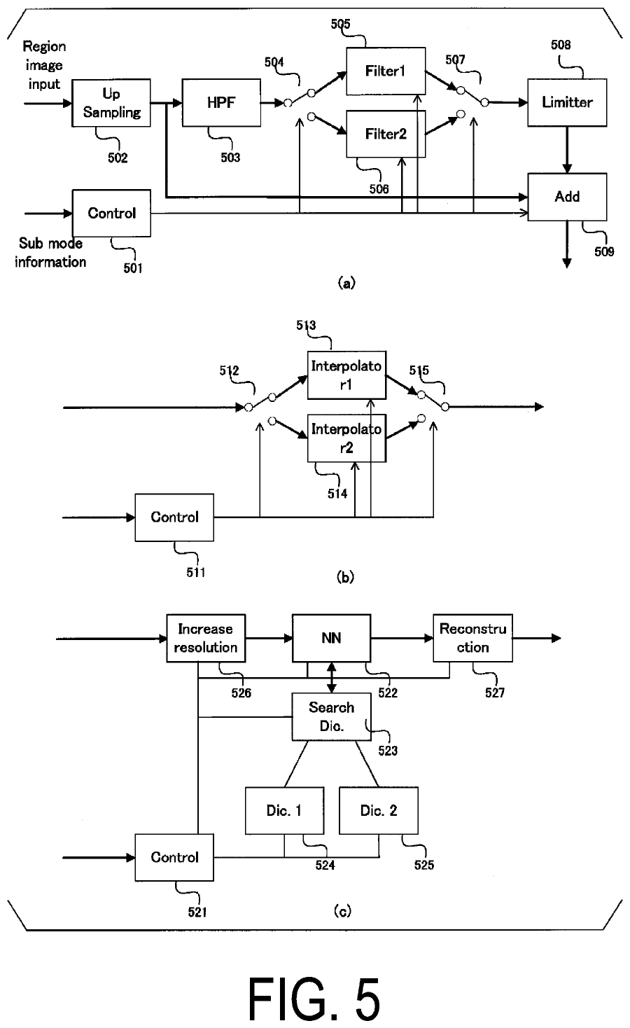

Next, an example of functional blocks inside the super resolution processing unit 405 will be described with reference to FIG. 4(b). 411 is a controller to which the information of the region, the super resolution processing method, and the sub-mode are input, and is configured to configure each unit of a first selection unit 415, a second selection unit 416, a sharpening function unit 412, an interpolation function unit 413, and a video reconstruction function unit 414, and perform super resolution processing on the video information of the region input by configuring each block. The first selection unit 415 selects a processing unit to be used, and the second selection unit 416 selects video data to be output from the selected processing unit to the second frame buffer unit 406. 412 is a sharpening function unit 412 configured to perform super resolution processing by sharpening, and is configured to, after performing super resolution processing by sharpening in the horizontal direction, perform sharpening processing in the vertical direction and perform sharpening processing on the entire picture. An example of functional blocks for performing the sharpening processing is illustrated in FIG. 5(a). FIG. 5(a) illustrates functional blocks for performing sharpening processing in one direction, but it is possible to sharpen the entire region by changing the scanning direction of the video signal to be input. Two types of processing can be configured as a method of sharpening, which includes unsharp mask processing and sharpening processing that uses harmonics using a non-linear function. 501 is a controller configured to control a first selection unit 504, a second selection unit 507, a first filter unit 505, and a second filter unit 506; 502 is an upsampling unit configured to upsample an input video signal; 503 is a high pass filter (HPF) unit configured to extract a high frequency portion of the upsampled video signal; 504 is a first selection unit configured to select a filter to be applied; 505 is a first filter unit configured to perform unsharp processing; 506 is a second filter unit configured to apply a non-linear function; 507 is a second selection unit configured to input the output of the filter selected by the controller to a limiter unit 508; 508 is a limiter unit configured to limit the amplitude of the filtered signal input from the second selection unit 507; and 509 is an addition unit configured to add an output of the limiter unit 508 and an upsampled signal. The first filter unit 505 is a filter configured to further emphasize the high frequency portion used for unsharp mask processing. The frequency characteristics of the first filter unit 505 can be controlled by the controller 501. The second filter unit 506 is a filter configured to generate harmonics by non-linear processing, and can use Equation 1 as an example. The gain a can be controlled by the controller 501.

$$f ( x ) = sign ( x ) \cdot α {x}^{2} \\ sign ( x ) = 1 ( x \geq 0 ) - 1 ( x < 0 ) \qquad Equation 1$$

The limiter unit 508 limits the amplitude amplified by the first filter unit 505 and the second filter unit 506 to a fixed value. In the present embodiment, the amplitude is limited to a predetermined value, but this value may be controlled by the controller 501. The addition unit 509 adds the upsampled video signal and the output of the first filter unit 505 to obtain a video signal that has been subjected to unsharp mask processing. By adding the upsampled video signal and the output of the second filter unit 506 by the addition unit 509, it is possible to obtain a video signal, in other word, a high resolution signal including a high frequency component not included in the upsampled video signal. The addition unit 509 delays and adds the upsampled video signal with a delay corresponding to the delay in passing the first filter unit 505 and the second filter unit 506.

413 is an interpolation function unit configured to perform super resolution processing by interpolation, and an example of the internal functional blocks is illustrated in FIG. 5(b). 511 is a controller configured to control a first selection unit 512, a second selection unit 515, a first interpolation unit 513, and a second interpolation unit 514; 512 is a first selection unit configured to switch the interpolation units to be applied; 513 is a first interpolation unit configured to perform interpolation by the bi-cubic method; 514 is a second interpolation unit configured to perform interpolation by the Lanczos3 method; and 515 is a second selection unit configured to select the output of the selected interpolation unit as the output of the interpolation function unit 413. The controller 511 configures sharpness of the output of the second interpolation unit 514 higher than the sharpness of the output of the first interpolation unit 513. This is because the Lanczos3 method has more reference points than the bi-cubic method, and the sharpness resulting from the interpolation can be configured to be higher.

414 is a video reconstruction function unit configured to perform super resolution processing by reconstructing the video based on the matching with dictionary or by using the neural network that uses dictionary data, and an example of the internal functional blocks is illustrated in FIG. 5(c). 521 is a controller configured to control the other functional blocks; 526 is a resolution conversion unit configured to convert the input video data to 8K resolution on a per frame basis; 522 is a neural network unit configured to sequentially read one frame of image data output by the resolution conversion unit 526, and output data detailed with reference to patch data stored in a first dictionary data unit 524 or a second dictionary data unit 525 to an image reconstruction unit 527; 527 is an image reconstruction unit configured to reconstruct an image with 8K resolution by utilizing the detailed image data output by the neural network unit 522, and output the reconstructed image data on a per frame basis; 523 is a dictionary search unit configured to configure the dictionary data unit in which the neural network unit 522 references to the patch data; and each of 524 and 525 is a first dictionary data unit and a second dictionary data unit configured to store patch data. The processing performed by the resolution conversion unit 526 is not limited. A processing method having a small amount of calculation, such as the nearest neighbor method or linear interpolation, may be used. The first dictionary data unit 524 and the second dictionary data unit 525 configured to store patch data suitable for the processing method performed by the resolution conversion unit 526 may be provided. The method used by the neural network unit 522 is not particularly limited, but in the present embodiment, a convolutional neural network is used. The neural network unit 522 acquires, from the resolution conversion unit 526, a processing unit of the image, for example, 3×3 pixels including the surrounding of the pixels of interest, obtains filter coefficients and weight coefficients for the convolution processing from the first dictionary unit 524 or the second dictionary unit 525 via the dictionary search unit 523, and outputs the maximum value resulting from the convolutional processing to the image reconstruction unit 527. The neural network unit 522 may have a multi-layer structure. The first dictionary unit 524 and the second dictionary unit 525 acquire learned dictionary data from the network management unit 114 in the network side device 101 via the controller 521. The neural network unit 522 performs the convolutional processing on all the pixels output by the resolution conversion unit 526, and the image reconstruction unit 527 performs, based on the result from the convolutional processing, reconstruction to perform the super resolution processing of 8K resolution. In a case that the region that is input to the video reconstruction function unit 414 is 100×100 pixels in 4K video data, the output of the video reconstruction function unit 414 is data of 200×200 pixels of 8K video data. In a case that information on the dictionary data suitable for use is obtained from the terminal information generation unit 120 or the like, the dictionary search unit 523 may fix the dictionary data unit used by the neural network unit 522 to either the first dictionary data unit 524 or the second dictionary data unit 525.

The super resolution processing unit 405 may select a processing method in which the lower the value of the rank, the less the computation processing, and the higher the value of the rank, the more the operations required. This reduces the computation processing required for super resolution processing of the entire picture by reducing the computation processing in regions where the rank value is low, and makes it possible to shorten the computation time required for the super resolution processing.

The terminal information generation unit 120 of the terminal side device 102 may perform the request for super resolution parameters to the region reconstruction information generation unit 108 via a network. In this case, the region reconstruction information generation unit 108 generates the super resolution parameters in accordance with the request for the super resolution parameters, and transmits the generated super resolution parameters to the terminal side device 102. Furthermore, the request for the super resolution parameters preferably includes the type of super resolution parameters available in accordance with the capability of the terminal side device 102. For example, in a case that the interpolation function or the sharpening function are available for the super resolution processing method, the interpolation function or the sharpening function is specified as the type. The type related to sub-mode may also be added to the request. For example, in a case that the unsharp or non-linear function is available for the sub-mode, the terminal information generation unit 120 requests the unsharp or non-linear function. The sub-mode requires the non-linear function as the type in a case that the non-linear function is available.

The request by the terminal information generation unit 120 may include parameters related to the classification information. For example, the request may include information on the maximum block size or the minimum block size used for the classification and the number of layers of block division. The request may also include the number of ranks.

The region reconstruction information generation unit 108 generates super resolution parameters in accordance with parameters related to the type or the classification information included in the request, and transmits the generated super resolution parameters to the terminal information generation unit 120. For example, in a case that the type specifies the unsharp or non-linear function, information of the unsharp or non-linear function is transmitted as a super resolution parameter. The super resolution parameters in accordance with the maximum block size, the minimum block size, the number of layers of block division, the number of ranks, and the like specified as the classification information are transmitted.

The super resolution processing unit 405 may perform processing such that a processed video signal is a video signal for not only an 8K video, but also a video with another resolution. In a case that the display capability of the video display unit 119 is less than display of an 8K video and is, for example, display capability of 5760 pixels×2160 pixels, the video data resulting from the super resolution processing may be processed so as to be 5760 pixels×2160 pixels. In a case that the display capability of the video display unit 119 has the number of pixels greater than 8K video, super resolution processing may be performed based on the number of pixels.

By operating each of the functional blocks as described above, the amount of information of the coded video data is reduced, and it is possible to display high quality super high resolution video by using slight region reconstruction information based on the video data supplied by the video distribution unit.

As illustrated in the embodiment above, in transmission or distribution of, for example, data of super high resolution video contents such as 8K video to the terminal side device 102, the network side device 101 generates low resolution video contents from the original super high resolution video contents to reduce the amount of information, performs video coding of the low resolution video contents, and transmits the low resolution video coded data resulting from the video coding, in accordance with transmission speed (transmission capacity, transmission band) of a wired network, a wireless network, a broadcast wave transmission line, or the like used for the transmission, and then generates and transmits information for indicating the characteristics of the original super high resolution video contents, for example, the region reconstruction information including information of division into regions having similar distributions of luminance information, chrominance information or the like, and indicating characteristics of each region, or the like. The terminal side device 102 reconstructs the 8K video by performing super resolution processing or the like, based on the region reconstruction information received from the network side device 101, on the low resolution video data obtained by decoding the low resolution video coded data received from the network side device 101. Note that in transmitting or distributing the same super high resolution video contents to multiple terminal side devices 102, multiple pieces of low resolution video coded data may be transmitted that are obtained by selecting different sizes of low resolution in accordance with the transmission speeds or the like of the transmission lines with the multiple terminal side devices 102 and by performing the video coding, and the region reconstruction information common to the multiple terminal side devices 102 may be generated and transmitted. With such a configuration, it is possible to reduce the amount of information of the video coded data in accordance with the transmission speed of the transmission line or the like in transmitting the super resolution video contents, and by performing, in the reconstruction, video processing such as super resolution processing using the region reconstruction information based on the original super high resolution video contents, it is possible to reconstruct and display a higher quality super high resolution video.

### Common to All Embodiments

A program running on an apparatus according to an aspect of the present invention may serve as a program that controls a Central Processing Unit (CPU) and the like to cause a computer to function in such a manner as to realize the functions of the embodiment according to the aspect of the present invention. Programs or the information handled by the programs are temporarily stored in a volatile memory such as a Random Access Memory (RAM), a non-volatile memory such as a flash memory, a Hard Disk Drive (HDD), or any other storage device system.

Note that a program for realizing the functions of the embodiment according to an aspect of the present invention may be recorded in a computer-readable recording medium. This configuration may be realized by causing a computer system to read the program recorded on the recording medium for execution. It is assumed that the “computer system” refers to a computer system built into the apparatuses, and the computer system includes an operating system and hardware components such as a peripheral device. The “computer-readable recording medium” may be any of a semiconductor recording medium, an optical recording medium, a magnetic recording medium, a medium dynamically retaining the program for a short time, or any other computer readable recording medium.

Each functional block or various characteristics of the apparatuses used in the above-described embodiment may be implemented or performed on an electric circuit, for example, an integrated circuit or multiple integrated circuits. An electric circuit designed to perform the functions described in the present specification may include a general-purpose processor, a Digital Signal Processor (DSP), an Application Specific Integrated Circuit (ASIC), a Field Programmable Gate Array (FPGA), or other programmable logic devices, discrete gates or transistor logic, discrete hardware components, or a combination thereof. The general-purpose processor may be a microprocessor or may be a processor of known type, a controller, a micro-controller, or a state machine instead. The above-mentioned electric circuit may include a digital circuit, or may include an analog circuit. In a case that with advances in semiconductor technology, a circuit integration technology appears that replaces the present integrated circuits, one or more aspects of the present invention can use a new integrated circuit based on the technology.

Note that the invention of the present patent application is not limited to the above-described embodiments. In the embodiment, apparatuses have been described as an example, but the invention of the present application is not limited to these apparatuses, and is applicable to a terminal apparatus or a communication apparatus of a fixed-type or a stationary-type electronic apparatus installed indoors or outdoors, for example, an AV apparatus, office equipment, a vending machine, and other household apparatuses.

The embodiments of the present invention have been described in detail above referring to the drawings, but the specific configuration is not limited to the embodiments and includes, for example, an amendment to a design that falls within the scope that does not depart from the gist of the present invention. Various modifications are possible within the scope of one aspect of the present invention defined by claims, and embodiments that are made by suitably combining technical means disclosed according to the different embodiments are also included in the technical scope of the present invention. A configuration in which constituent elements, described in the respective embodiments and having mutually the same effects, are substituted for one another is also included in the technical scope of the present invention.

### INDUSTRIAL APPLICABILITY

An aspect of the present invention can be used for a video processing apparatus. An aspect of the present invention can be utilized, for example, in a communication system, communication equipment (for example, a cellular phone apparatus, a base station apparatus, a wireless LAN apparatus, or a sensor device), an integrated circuit (for example, a communication chip), or a program.

### REFERENCE SIGNS LIST

101 Network side device
102 Terminal side device
103 Video distribution unit
104 Video signal supply unit
105 Network apparatus
106 Image information reduction unit
107 Video coding unit
108 Region reconstruction information generation unit
109 Region selection unit
110 Feature extraction unit
111 Reconstruction information generation unit
112 Signal multiplexing unit
113 Base station apparatus
114 Network management unit
115 Terminal information control unit
116 Terminal wireless unit
117 Video decoding unit
118 Video reconstruction unit
119 Video display unit
120 Terminal information generation unit
401 Controller
403 First frame buffer unit
404 Region extraction unit
405 Super resolution processing unit
406 Second frame buffer unit
411 Controller
412 Sharpening function unit
413 Interpolation function unit
414 Video reconstruction function unit
415 First selection unit
416 Second selection unit
501 Controller
502 Upsampling unit
503 High pass filter unit
504 First selection unit
505 First filter unit
506 Second filter unit
507 Second selection unit
508 Limiter unit
509 Addition unit
511 Controller
512 First selection unit
513 First interpolation unit
514 Second interpolation unit
515 Second selection unit
521 Controller
522 Neural network unit
523 Dictionary search unit
524 First dictionary data unit
525 Second dictionary data unit
526 Resolution conversion unit
527 Image reconstruction unit

1. A video processing apparatus configured to be connected to a prescribed network, the video processing apparatus comprising:
a data input unit configured to acquire a first video;
a video processing unit configured to divide the first video into multiple regions and generate multiple pieces of region reconstruction information associated with the first video for each of the multiple regions; and
a data output unit configured to transmit the multiple pieces of the region reconstruction information to a terminal side device connected via the prescribed network.

2. The video processing apparatus according to claim 1, wherein
the video processing unit acquires information associated with a method for generating the region reconstruction information from the terminal side device.

3. The video processing apparatus according to claim 1, wherein
each of the region reconstruction information generated for each of the multiple regions has a different amount of information.

4. The video processing apparatus according to claim 1, wherein
the data input unit acquires classification information associated with the first video, and
the video processing unit generates the region reconstruction information, based on the classification information.

5. The video processing apparatus according to claim 4, wherein
the data input unit further requests a request of the region reconstruction information for the video processing unit configured to generate the region reconstruction information.

6. The video processing apparatus according to claim 5, wherein
the request of the region reconstruction information includes a type of the region reconstruction information.

7. The video processing apparatus according to claim 5, wherein
the request of the region reconstruction information includes a parameter related to the classification information.
